(19) United States
(12) Patent Application Publication
(10) Pub. No.: US 2023/0385920 A1
(43) Pub. Date: Nov. 30, 2023

(54) System and Method For Browsing in a Plurality of Aisles in a Virtual Storefront

(71) Applicant: Rifka Freier, Brooklyn, NY (US)

(72) Inventor: Rifka Freier, Brooklyn, NY (US)

(21) Appl. No.: 18/322,078

(22) Filed: May 23, 2023

Related U.S. Application Data
(60) Provisional application No. 63/345,240, filed on May 24, 2022.

(51) Int. Cl. G06Q 30/0601; G06Q 30/0207

(52) U.S. Cl. CPC G06Q 30/0643; G06Q 30/0239

(57) ABSTRACT

A system for browsing in a plurality of aisles in a virtual storefront is provided. The overall system is designed to provide a customer with a virtual storefront that the customer may browse for items within defined aisles. The virtual storefront is tied to a physical store in terms of its layout and inventory. The overall system will provide a virtual shopping cart in which items selected by the customer may be stored. The items will be moved into the shopping cart when they are touched by the customer within the virtual environment. The overall system further includes search functions and payment functions, as well as the ability to use coupons, enable notifications or product stock alerts and store favorite products.

### CROSS REFERENCE TO RELATED APPLICATIONS

This application claims the benefit of U.S. Provisional Application No. 63/345,240 filed on May 24, 2022. The above identified patent application is herein incorporated by reference in its entirety to provide continuity of disclosure.

### BACKGROUND OF THE INVENTION

The present invention relates to a system for browsing. More specifically, the present invention relates to a system for browsing in a plurality of aisles in a virtual storefront.

For years, retail shopping has become an increasingly virtual experience. In the wake of government restrictions and consumer hesitancy associated with the Covid-19 pandemic, online shopping has become an increasingly popular alternative to physically shopping in a store. This has not only been the case younger and more technically inclined individuals, but also for consumers who had historically not engaged in online shopping.

There are many advantages to online shopping. These include the ease of searching for items, the ability to shop from the comfort of one's home, and the reduced costs of transportation to and from a physical store. However, there are also disadvantages associated with online shopping. For example, online shopping deprives consumers of the ability to fully browse and explore the products available in a marketplace. This is because online marketplaces lack aisles through which the consumer can wander. Although online marketplaces do provide a limited ability to browse items by category, they still do not provide the same ease of access. Furthermore, consumers may not be able to purchase every item they need or want if they are not able to see the product while shopping.

Therefore, there is a defined need amongst the existing systems for organizing and presenting an online marketplace. As businesses and consumers continue to transition towards online retail, the need for an interface that provides consumers with the ability to browse a marketplace in a more traditional sense is desired.

Such a system will provide convenience to the consumers in the form of an easier way to see related products, as well as providing convenience to the retailer by allowing for enhanced product placement.

### SUMMARY OF THE INVENTION

In view of the foregoing disadvantages inherent in the known types of systems for browsing in a plurality of aisles in a virtual storefront now present in the prior art, the present invention provides a system for browsing in a plurality of aisles in a virtual storefront wherein the same can be utilized for providing convenience for the user when using a system for browsing in a plurality of aisles in a virtual storefront.

The present system comprises a system for browsing in a plurality of aisles in a virtual storefront, a server system with a processor system, a communications interface, a communications system, an input system and an output system, the server system having access to a communications network, a memory system with an operating system, a communications module, a web browser module, a web server application and a non-transitory storage media for browsing in a plurality of aisles in a virtual storefront. The memory system is in communication with the server system through the communications network, and a virtual storefront displayed on the external touch display screen, wherein the virtual storefront having a plurality of screenshots that reside on the non-transitory storage media for browsing in a plurality of aisles in a virtual storefront.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of a system for browsing in a plurality of aisles in a virtual storefront.

FIG. 2A shows a block diagram of a client system of the system for virtual storefront having a plurality of aisles.

FIG. 2B illustrates a block diagram of a server system of the system fora virtual storefront having a plurality of aisles.

FIG. 3 shows a plurality of screenshots of an embodiment of the system for enhancing online marketplace browsing.

FIG. 4 shows a demonstrative view of a store screenshot of an embodiment of the system for enhancing online marketplace browsing.

FIG. 5 shows a demonstrative view of a screenshot of an embodiment of the system for enhancing online marketplace browsing.

FIG. 6 shows a demonstrative view of a customer service chat screenshot of an embodiment of the system for enhancing online marketplace browsing.

### DETAILED DESCRIPTION OF THE INVENTION

Reference is made herein to the attached drawings. Like reference numerals are used throughout the drawings to depict like or similar elements of the system for virtual storefront having a plurality of aisles. The figures are intended for representative purposes only and should not be considered to be limiting in any respect.

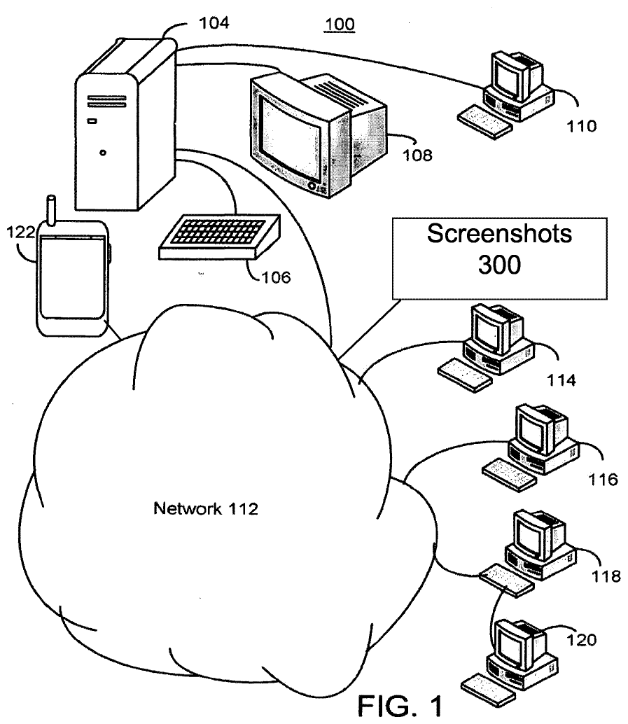

Referring now to FIG. 1 there is shown a system overview of a system for a virtual storefront having a plurality of aisles 100.

The overall system 100 includes a server system 104, an input system 106, an output system 108, a plurality of client systems 110, 114, 116, 118 and 120, a communications network 112, a hand-held device 122 and a virtual storefront having a plurality of aisles 300. In other embodiments, the overall system 100 may include additional components and/or may not include all of the components listed above.

The server system 104 may include one or more servers. One server 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118 and 120 are any system that an end user may use to access the server system 104. For example, the client systems 110, 114, 116, 118 and 120 may be personal computers, desktop computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

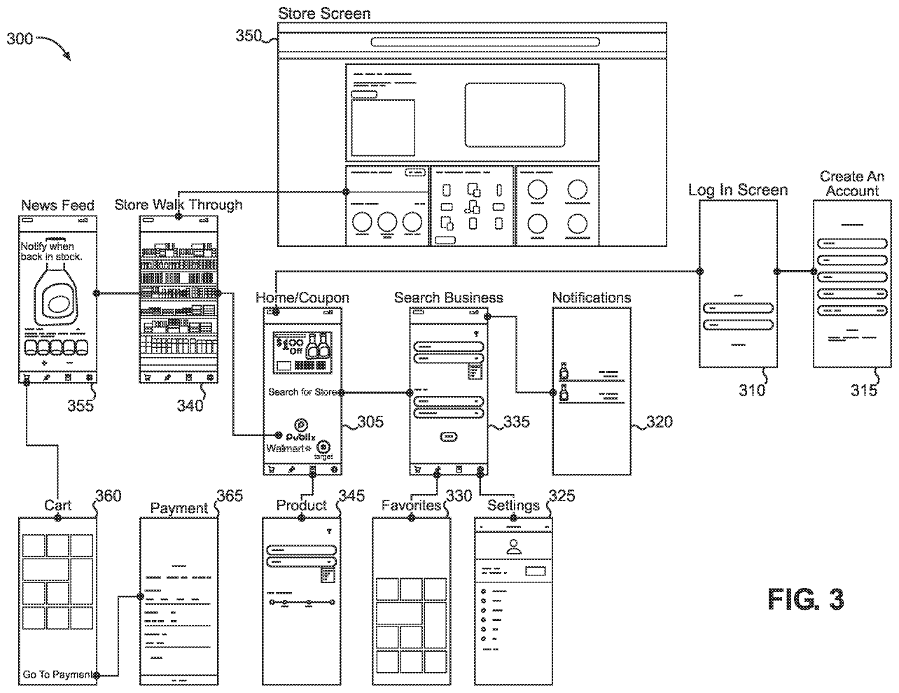

The virtual storefront having a plurality of screenshots 300 is described in more detail in FIGS. 3-5.

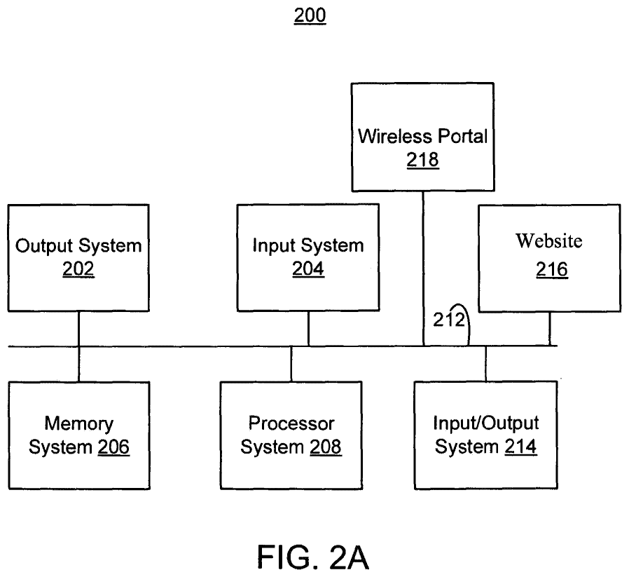

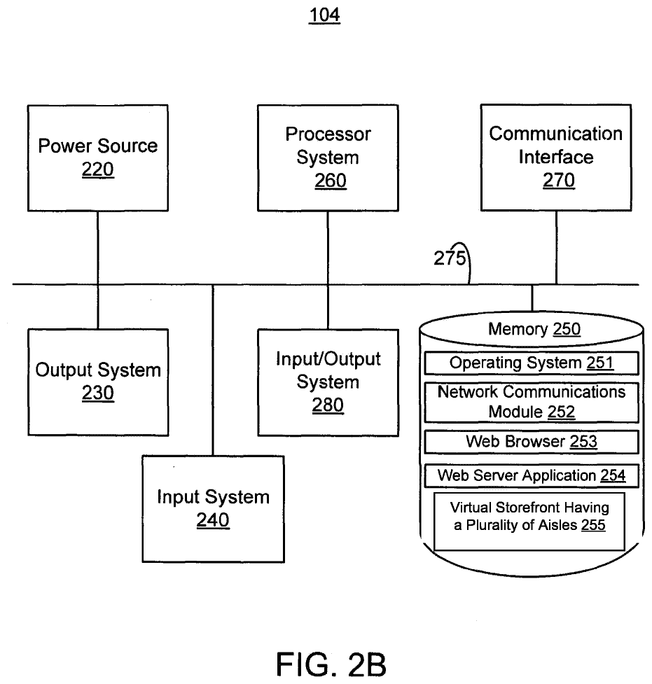

Referring now to FIG. 2A there is shown a block diagram of a client system 200 of the system for virtual storefront having a plurality of aisles 100.

The client system 200 may include an output system 202, an input system 204, a memory system 206, a processor system 208, a communications system 212, an input/output system 214, a website 216 and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., infrared Data Association or IrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine-readable mediums that may store a variety of different types of information. The term machine-readable medium is used to refer to any medium that is structurally configured for carrying information in a format that is readable by a machine. One example of a machine-readable medium is a computer-readable medium. The memory system 206 also stores a non-transitory storage media browsing in a plurality of aisles in a virtual storefront.

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include software and a website module (no number) to maintain, allow access to and run the website as well.

FIG. 2B shows a block diagram of a server system 104 of the system for browsing in a plurality of aisles in a virtual storefront 100.

The server system 104 may include a power source 220, an output system 230, an input system 240, a memory system 250, which may store an operating system 251, a communications module 252, a web browser module 253, a web server application 254, and a non-transitory storage media browsing in a plurality of aisles in a virtual storefront 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine-readable mediums that may store a variety of different types of information. The term machine-readable medium is used to refer to any medium capable of carrying information that is readable by a machine. One example of a machine-readable medium is a computer-readable medium. The memory system 250 may store one or more machine instructions for reading, searching, and enhancing a system for browsing in a plurality of aisles in a virtual storefront. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system 280 is optional and may be used in addition to or in place of the output system 230 and/or the input device 240.

Referring now to FIG. 3 there is shown a plurality of screenshots 300 of an embodiment of the application for enhancing online marketplace browsing.

The screenshots 300 may include a Home screenshot 305, a Log-In screenshot 310, a Create an Account screenshot 315, a Notifications screenshot 320, a Settings screenshot 325, a Favorites screenshot 330, a Search Business screenshot 335, a Virtual Marketplace screenshot 340, a plurality of specific products across multiple stores screenshot 345, a Store screenshot 350, a Product Information screenshot 355, a Cart screenshot 360, and a Payment screenshot 365.

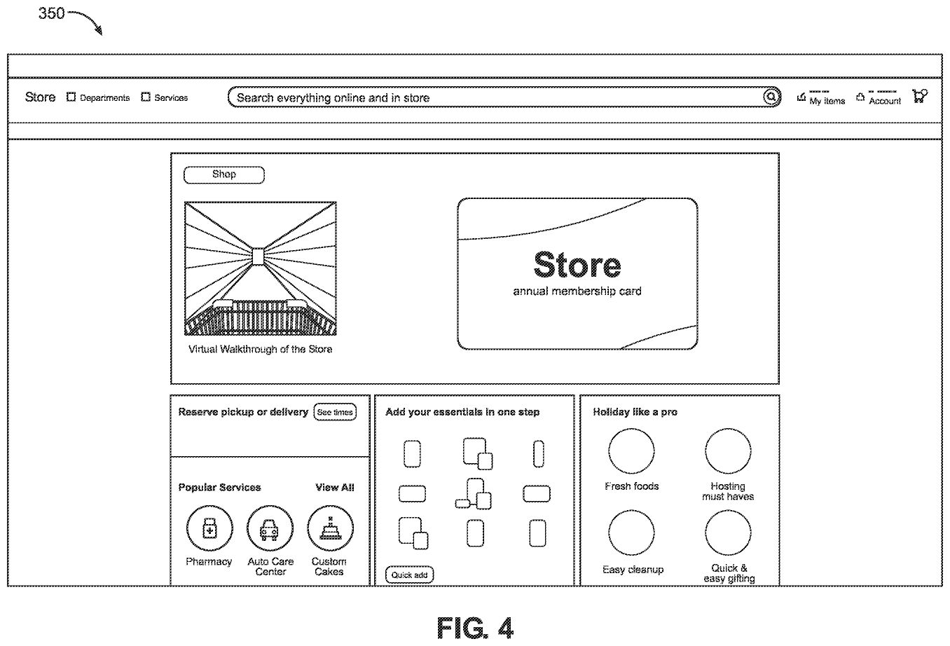

The Home screenshot 305 may provide the consumer with access to one or more coupons. The Log-In screenshot 310 may be accessed from the Home screenshot 305 to log-in to the overall system 100. The Log In screenshot 310 may be used without having to login. The user may browse/shop and only need to login when ready to checkout/pay. The user is able to experience the mobile application first without being interrupted with the need to immediately login. The Log In screenshot 310 may be accessed while visiting a specific store from the Store screenshot 350. The user may access the Log-In screenshot 310 or a Create an Account screenshot 315 to create and maintain a profile through which he or she may save preferences, payment information, and the like. The Notifications screenshot 320 may be accessed from the Home screenshot 305. The Settings screenshot 325 may allow a consumer to access and modify notifications from a plurality of settings. The Favorites screenshot 330 may save one or more favorite stores and/or products from the Favorites screenshot 330. The Search Business screenshot 335 may allow the consumer to further search for stores at which they may shop using the overall system 100 through the Home screenshot 305. The Virtual Marketplace screenshot 340 may alternatively allow the consumer to directly enter by selecting a tile corresponding to the store directly from the Home screenshot 305. The specific products across the multiple stores screenshot 345 may allow the consumer to search for specific products across multiple stores through which the consumer may access a plurality of additional options and interfaces. The specific products across multiple stores screenshot 345 may allow the consumer to search for specific products while browsing the aisles. Once a consumer searches for a specific product they will be navigated directly to view the aisle or location where the product can be found within the store. The Store screenshot 350 may include a website (FIG. 2A, 216) or the like and is described in more detail in FIG. 4. The Store screenshot 350 may include a plurality of live video from the store that gets screened/updated daily, as well as the option to have it be a placeholder image of the store. The Store screenshot 350 may give the user the experience as if they are strolling the aisles of the stores with their mouse or finger. The Store screenshot 350 may include a plurality of whole aisles and an entire store to be three-dimensional. The Product Information screenshot 355 may include a plurality of product photos 356 or the like and is described in more detail in FIG. 4. The Cart screenshot 360 may include a plurality of products 362 that the user desires to purchase. The Cart screenshot 360 may include the ability for the user to add items to their cart by clicking on the item. The Cart screenshot 360 may include one or more three-dimensional images at checkout. The Cart screenshot 360 may also include a cart/mouse icon that provides the user with the ability to stroll through the store in a three-dimensional manner. The Cart screenshot 360 may further include a three-dimensional shopping cart moving along with a three-dimensional shopper pushing the shopping cart. The Payment screenshot 365 may include a plurality of payment methods 366 such as a plurality of credit card information 367, a plurality of fintech information 368 or the like.

FIG. 4 shows a demonstrative view of the Store screenshot 350 of an embodiment of the system for enhancing online marketplace browsing 100.

The Store screenshot 350 may enable access to the virtual marketplace screenshot (FIG. 3, 340). The Virtual Marketplace screenshot 340 may be modeled after the physical store to which the Virtual Marketplace screenshot 340 corresponds. For example, the Virtual Marketplace screenshot 340 defines a layout through which the aisles that the consumer can browse are stocked with products that are placed in a position corresponding to the placement of the products within the physical store. The Virtual Marketplace screenshot 340 allows the user to zoom in and out of the aisles. As such, the consumer will be able to browse and view products in the manner that the store organizer intended. Additionally, if the consumer is familiar with the physical store, he or she will not struggle to locate the products that he or she is looking for. In one embodiment, the Virtual Marketplace screenshot 340 may be a three-dimensional recreation of the physical store providing length, breadth, and depth.

Once the consumer selects an item in the Virtual Marketplace screenshot 340, he or she will be directed to the Product Information screenshot (FIG. 3, 355). The Product Information screenshot 355 contains information about the product, such as the price, the availability, and the like. The consumer can add the product to the Cart screenshot (FIG. 3, 360), where the product will be stored while the consumer continues to shop for additional items. The Product Information screenshot 355 may include the ability to select an item and view it from all sides so that the user may look at a label, one or more ingredients, one or more nutrition facts, or the like. Once the consumer has filled his or her Cart screenshot 360 with the products they wish to purchase, they may pay for the items via the Payment screenshot (FIG. 3, 365). The consumer may also have the option to select if they would like the purchased products to be picked up at a store location or delivered to a location of the consumer's choice. The consumer may pay for the items through the Payment screenshot 365 by any suitable payment method.

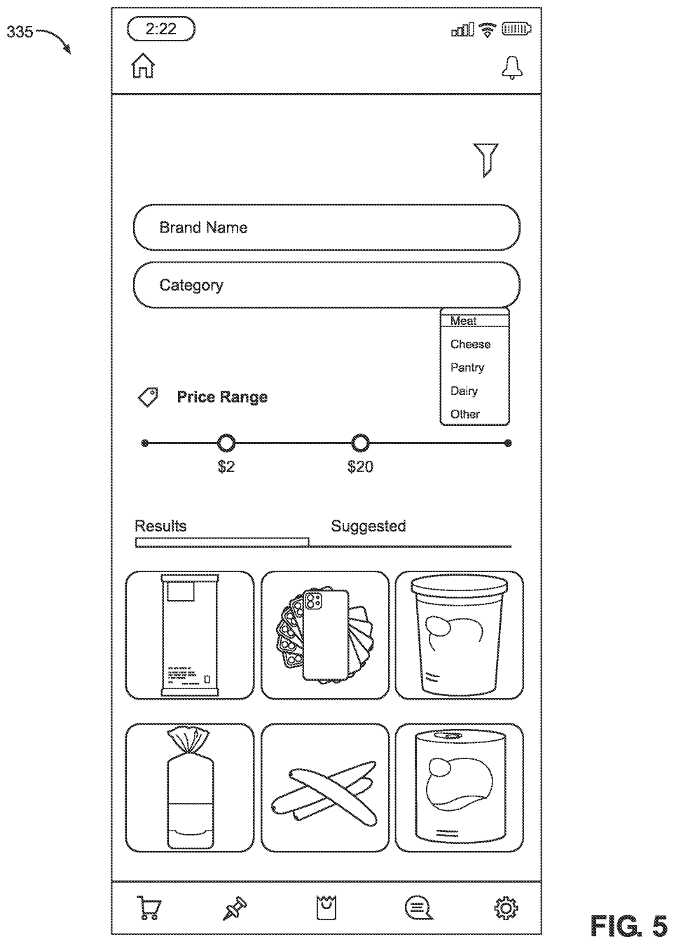

FIG. 5 shows a demonstrative view of the Search Business screenshot 335 of the overall system (FIG. 1, 100) for enhancing online marketplace browsing.

A demonstration of the Search Business screenshot 335 is shown in FIG. 5. In the demonstrated embodiment, the Virtual Marketplace screenshot (FIG. 3, 340) is further accessible directly from the Store screenshot (FIG. 4, 350) that may include a website (FIG. 2A, 216) or the like.

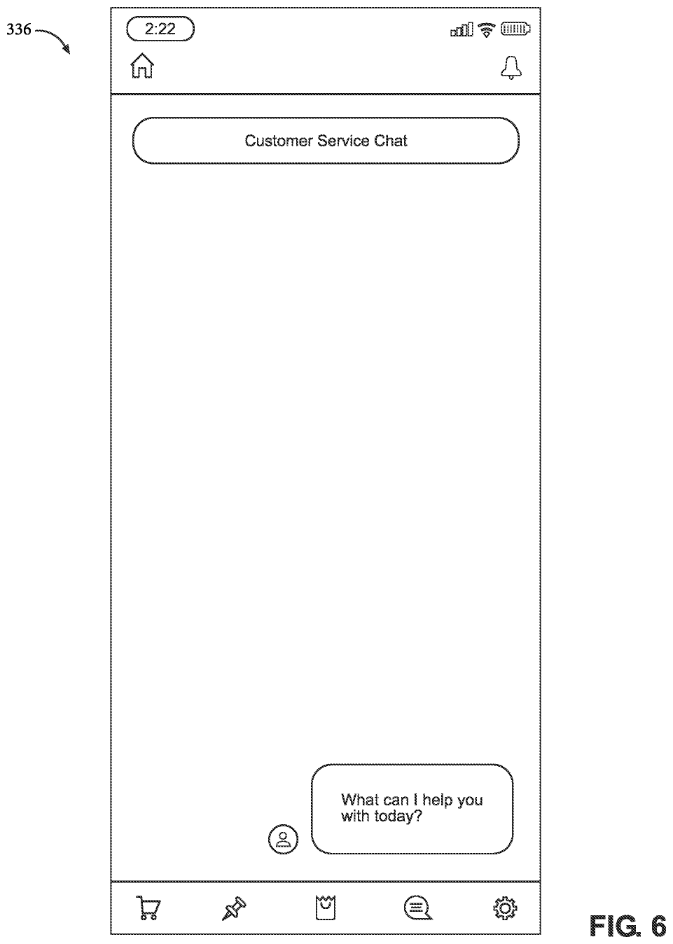

FIG. 6 shows a demonstrative view of a Customer Service Chat screenshot 336 of an embodiment of the system for enhancing online marketplace browsing. In the demonstrated embodiment, the Customer Service Chat screenshot 336 may be accessible by the consumer at any point during online marketplace browsing. The consumer may utilize the Customer Service Chat screenshot 336 to inquire about help with finding a particular item, checking on the stock of a particular item, or request general assistance with using the application. The Customer Service Chat screenshot 336 may have the ability for a consumer to live chat with a customer service representative. In an alternate embodiment, the Customer Service Chat screenshot 336 may also have the ability to provide the consumer with predetermined responses to general questions.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system, comprising:
a server system with a processor system, a communications interface, a communications system, an input system and an output system, the server system having access to a communications network;
a memory system with an operating system, a communications module, a web browser module, a web server application, and a non-transitory storage media for browsing in a plurality of aisles in a virtual storefront, the memory system is in communication with the server system through the communications network; and
a virtual storefront displayed on the external touch display screen;
wherein the virtual storefront having a plurality of screenshots that reside on the non-transitory storage media for browsing in a plurality of aisles in a virtual storefront; and
wherein the virtual storefront resides on a website residing on the non-transitory storage media for browsing in a plurality of aisles in a virtual storefront.

2. The system according to claim 1, further comprising a client system that accesses the server system via the communications network.

3. The system according to claim 2, wherein the client system is selected from the group consisting of a smart phone, a tablet computer, a laptop computer, a personal computer, or a desktop computer.

4. The system according to claim 1, wherein the screenshots include a Home Screenshot, a Log-in screenshot, a Create an Account screenshot, a Notifications screenshot, a Settings screenshot, a Favorites screenshot, a Search Business screenshot, a Virtual Marketplace screenshot, a plurality of specific products across multiple stores screenshot, a Store screenshot, a Product Information screenshot, a Cart screenshot, a Payment screenshot, and a Customer Service Chat screenshot.

5. The system according to claim 4, wherein the Home Screenshot provides access to one or more coupons.

6. The system according to claim 4, wherein the Log-In screenshot is accessed from the Home screenshot to log-in to the overall system.

7. The system according to claim 4, wherein the Create an Account screenshot creates and maintains a profile through which save one or preferences and one or more payment information.

8. The system according to claim 4, wherein the Notifications screenshot is accessed from the Home screenshot.

9. The system according to claim 4, wherein the Settings screenshot allows access to and modify one or more notifications from a plurality of settings.

10. The system according to claim 4, wherein the Favorites screenshot saves one or more favorite stores and/or products from the Favorites screenshot.

11. The system according to claim 4, wherein the Search Business screenshot allows to further search for one or more stores to shop using the overall system through the Home screenshot.

12. The system according to claim 4, wherein the Virtual Marketplace screenshot alternatively allows a consumer to directly enter by selecting a tile corresponding to the store directly from the Home screenshot.

13. The system according to claim 4, wherein the products across multiple stores screenshot allow to search for the products across multiple stores through which the consumer may access a plurality of additional options and interfaces.

14. The system according to claim 4, wherein the Virtual Marketplace screenshot includes a live video of the store.

15. The system according to claim 14, wherein the Virtual Marketplace screenshot is further accessible directly from the Store screenshot that includes the website.

16. The system according to claim 14, wherein the Virtual Marketplace screenshot is a three-dimensional recreation of a physical store providing length, breadth, and depth.

17. The system according to claim 16, wherein the Virtual Marketplace screenshot is modeled after a physical store to which the Virtual Marketplace screenshot corresponds.

18. The system according to claim 16, wherein the Virtual Marketplace screenshot defines a layout through which the aisles that are browsed are stocked with the products that are placed in a position corresponding to the placement of the products within the physical store.

19. The system according to claim 4, wherein the Product Information screenshot includes a plurality of product photos.

20. The system according to claim 4, wherein the Payment screenshot include a plurality of payment methods that include a plurality of credit card information and a plurality of fintech information.
